(19) United States
(12) Patent Application Publication
(10) Pub. No.: US 2008/0065397 A1
(43) Pub. Date: Mar. 13, 2008

(54) Managing composite enterprise services through multi-layer decomposition

(76) Inventors: Ying Huang, Yorktown Heights, NY (US); Jen-Yao Chung, Yorktown Heights, NY (US)

Correspondence Address: F. CHAU & ASSOCIATES, LLC, 130 WOODBURY ROAD, WOODBURY, NY, 11797, US

(21) Appl. No.: 11/518,081

(22) Filed: Sep. 8, 2006

(51) Int. Cl. G06Q 10/00; G06Q 30/00

(52) U.S. Cl. 705/1; 370/469

(57) ABSTRACT

A method and system are provided for managing composite enterprise services, the method including performing a multi-layer decomposition of the composite enterprise services, receiving at least one quality-of-service (QoS) request, and managing the composite enterprise services in accordance with the multi-layer decomposition and the at least one quality-of-service request; and the system including a processor, a multi-layer decomposition unit in signal communication with the processor for performing a multi-layer decomposition of the composite enterprise services, an adapter in signal communication with the processor for receiving at least one quality-of-service request, and a composite enterprise services management unit in signal communication with the processor for managing the composite enterprise services in accordance with the multi-layer decomposition and the at least one quality-of-service request.

### BACKGROUND

The present disclosure generally relates to enterprise services, and more particularly relates to managing enterprise services that are composed of other services. The other services may be provided by internal or external service providers in a service-oriented enterprise environment.

In current approaches, the management of such composite services is primarily manual. The description of such services uses flow-based service compositions, such as business process execution language for Web services (BPEL4WS).

The current manual approaches are insufficient to handle large-scale and complex enterprise service management, particularly in the presence of outsourcing partners. For example, business process execution language for Web services is designed for the description of a single service flow, and can capture only a single dimension of composite services. This is inadequate for the efficient management of all aspects of the services.

### SUMMARY

These and other drawbacks and disadvantages of the prior art are addressed by a method, system and program storage device for managing composite enterprise services through multi-layer decomposition.

A method of managing composite enterprise services includes performing a multi-layer decomposition of the composite enterprise services, receiving at least one quality of service (QoS) request, and managing the composite enterprise services in accordance with the multi-layer decomposition and the at least one quality-of-service request.

A system for managing composite enterprise services includes a processor, a multi-layer decomposition unit in signal communication with the processor for performing a multi-layer decomposition of the composite enterprise services, an adapter in signal communication with the processor for receiving at least one quality-of-service request, and a composite enterprise services management unit in signal communication with the processor for managing the composite enterprise services in accordance with the multi-layer decomposition and the at least one quality-of-service request.

A program storage device readable by machine, tangibly embodying a program of instructions executable by the machine to perform program steps for managing composite enterprise services, includes program steps for performing a multi-layer decomposition of the composite enterprise services, receiving at least one quality-of-service request, and managing the composite enterprise services in accordance with the multi-layer decomposition and the at least one quality-of-service request.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a method and system for managing composite enterprise services through multi-layer decomposition in accordance with the following exemplary figures, in which:

FIG. 1 shows a schematic diagram for varieties of business and information technology (IT) enterprise services in accordance with an illustrative embodiment of the present disclosure;

FIG. 2 shows a schematic diagram for an exemplary three-layer decomposition of typical enterprise services in accordance with an illustrative embodiment of the present disclosure;

FIG. 3 shows a schematic diagram of an extended service description for three-layer decomposition in accordance with an illustrative embodiment of the present disclosure;

FIG. 4 shows a schematic diagram of an extended mark-up language (XML) schema for the extended service description in accordance with an illustrative embodiment of the present disclosure;

FIG. 5 shows a schematic diagram of a modeling framework for managing composite enterprise services with a multi-layer decomposition in accordance with an illustrative embodiment of the present disclosure;

FIG. 6 shows a schematic diagram for the interactions among the multiple layers of composite enterprise services in accordance with an illustrative embodiment of the present disclosure;

FIG. 7 shows a schematic diagram of methods for managing composite enterprise services with multi-layer decomposition including problem identification and making tradeoffs in accordance with an illustrative embodiment of the present disclosure;

FIG. 8 shows a schematic diagram of the interactions among multiple layers of composite enterprise services in accordance with an illustrative embodiment of the present disclosure; and

FIG. 9 shows a table of methods for managing composite enterprise services with multi-layer decomposition including problem identification and tradeoffs in accordance with an illustrative embodiment of the present disclosure.

### DETAILED DESCRIPTION OF PREFERRED EMBODIMENTS

A system and method are provided for managing composite enterprise services through multi-layer decomposition. A new form is disclosed for defining the operational management flows that are suitable in a service-oriented enterprise service composition. The form explicitly describes the three distinctive responsibilities of service providers in a composite enterprise service, and facilitates the development of integration solutions supporting the corresponding composite enterprise services.

This disclosure teaches a multi-layer decomposition of the enterprise services that permits more efficient description and management of composite enterprise services; a schema definition for an extended service description that captures additional perspectives that are useful for the composite service management; and a classification of enterprise services that facilitates the proper management of such services. An exemplary embodiment shows a three-layer decomposition, which may be extended to any number of layers.

The multi-layer decomposition approach in this disclosure provides a systematic way of describing and managing composite enterprise services. The disclosure provides a mechanism for the management of enterprise services through multi-layer decomposition. It deals with the issues of execution process design and operational management for enterprise services. An enterprise service is typically a composite service, that is, a composition of several business and information technology (IT) services. The service providers participating in the composite service may represent those within the enterprise as well as those from outside of the enterprise, namely the outsourced service providers.

There are multiple dimensions of this composite service that have to be captured, such as strategic intent, operational procedure, and execution details. A feature of the presently disclosed service management mechanism provides a decomposition view of the overall management process for the services into multiple distinctive layers, and finds appropriate tradeoffs among the concerns with respect to the different layers.

As used herein, a logical layer is a sequence of services with a composition that describes the business and information technology operation details to enable the achievement of desired business goals. A physical layer represents the actual execution of the services in a particular sequence. A quality-of-service (QoS) layer is a sequence of the quality of service descriptions of the services that describe the quality-of-service details to enable the achievement of desired quality-of-service targets.

Thus, the physical layer may be associated with a description of the concrete execution implementation of the composite services. The logic layer provides a view of management control over the information and operational activities, and the quality-of-service layer describes the critical information about the composite service in terms of quality of service.

By decomposing the overall service management processes into these three layers, one can design an execution process and manage the actual operation to achieve pre-specified business goals observing service agreements and ensuring proper physical executions.

The modeling framework has three interrelated levels. A service goals and constraints level results from the economic evaluation and agreement development. It provides both goals and constraints for the composite integration level for execution. A composite integration level provides specific execution elements for integrating all the services together, at the logic, physical and quality-of-service layers. In addition, it also provides the necessary human and system adapters for various kinds of connectivity. More importantly, the tradeoffs for intelligently composing the services at different layers are provided for achieving business goals and performance targets. A control services level supplies further support for the common system services for different types of business and information technology controls.

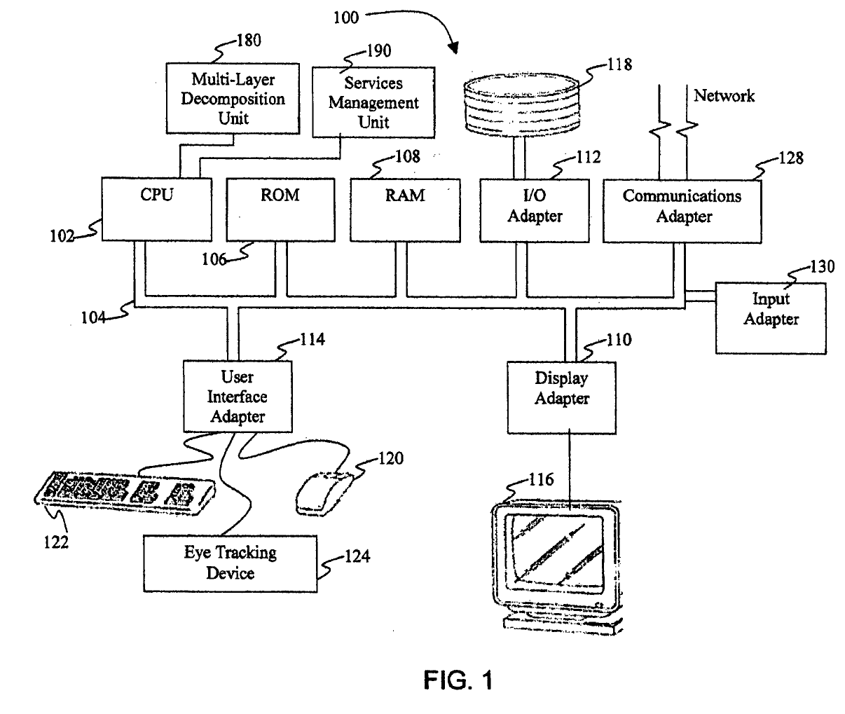

As shown in FIG. 1, a system for automatically managing composite enterprise services through multi-layer decomposition, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114 and a communications adapter 128 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114. An input adapter 130 is in signal communication with the system bus 104 and the CPU 102.

A multi-layer decomposition unit 180 and a composite enterprise services management unit 190 are also included in the system 100 and in signal communication with the CPU 102 and the system bus 104. While the multi-layer decomposition unit 180 and the composite services management unit 190 are illustrated as coupled to at least one processor or CPU 102, these components are preferably embodied in computer program code stored in at least one of the memories 106, 108 and 118, wherein the computer program code is executed by the CPU 102.

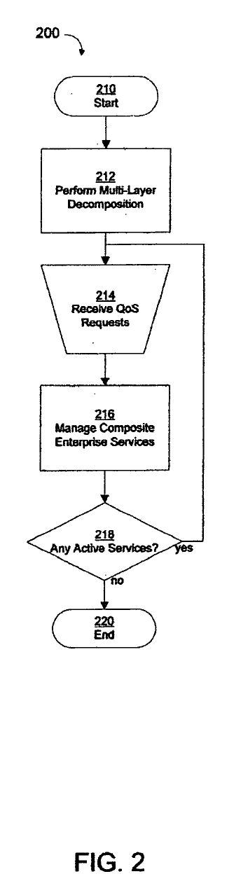

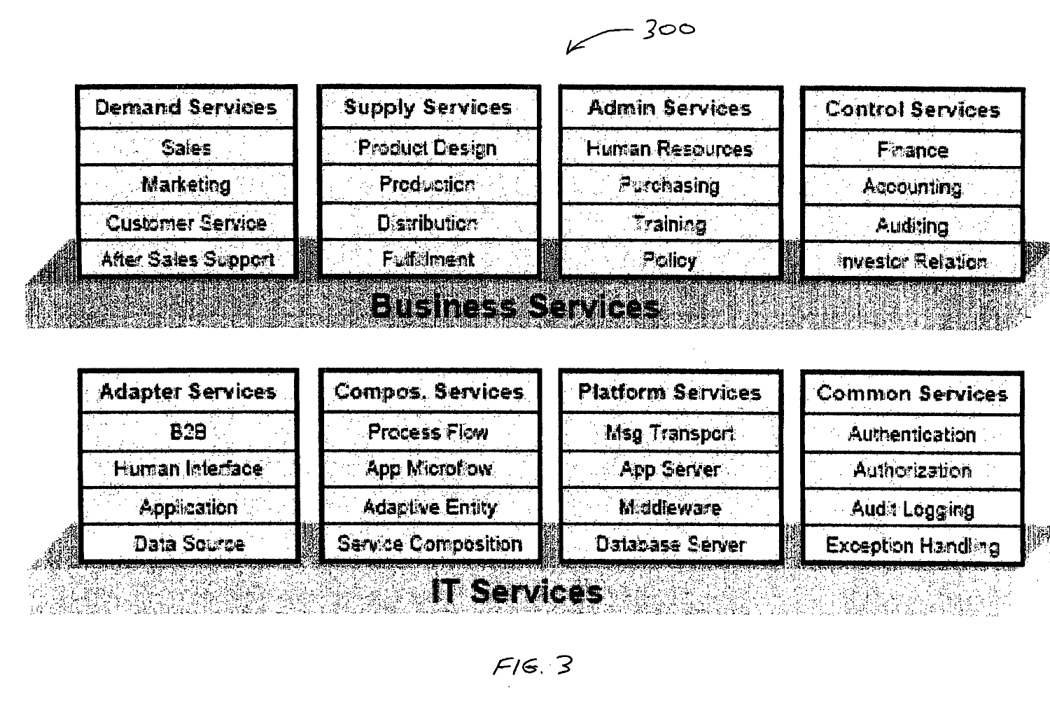

Turning to FIG. 2, a method for automatically managing composite enterprise services through multi-layer decomposition is indicated generally by the reference numeral 200. The method 200 includes a start block 210, which passes control to a function block 212. The function block 212 performs a multi-layer decomposition of composite enterprise services, and passes control to an input block 214. The input block 214, in turn, receives quality-of-service requests, such as from a master, client or operator, and passes control to a function block 216. The function block 216 automatically manages the composite enterprise services in accordance with the multi-layer decomposition and any quality-of-service requests, and passes control to a decision block 218. The decision block 218 determines whether there are any active services, and if so, passes control back to the input block 214. If not, the decision block passes control to an end block 220.

As shown in FIG. 3, varieties of business and information technology enterprise services that can be involved in the composite enterprise services to be managed are indicated generally by the reference numeral 300. Here, the composite enterprise services may include business services and/or information technology services. The business services may include demand services, supply services, administrative services and/or control services. The demand services may include sales, marketing, customer service and/or after sales support. The supply services may include product design, production, distribution and/or fulfillment. The administrative services may include human resources, purchasing, training and/or policy. The control services may include finance, accounting, auditing and/or investor relations.

The information technology services may include adapter services, composition services, platform services and/or common system services. The adapter services may include business-to-business (B2B), human interface, application and/or data source. The composition services may include process flow, application micro-flow, adaptive entity, and/or service composition. The platform services may include message transport, application server, middleware, and/or database server. The common system services may include authentication, authorization, audit logging and/or exception handling.

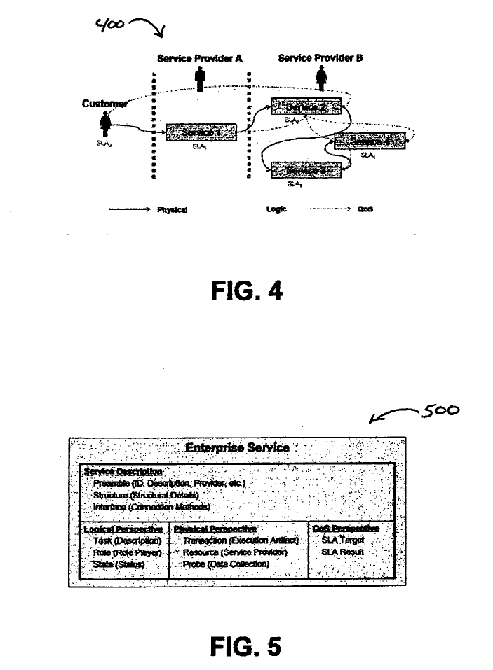

Turning to FIG. 4, a three-layer decomposition of typical enterprise services that embodies a concept of this disclosure is indicated generally by the reference numeral 400. In the exemplary embodiment decomposition 400 of FIG. 4, a multi-layer decomposition of the enterprise services permits a more efficient description and management of composite dynamic enterprise services than was possible under the prior art.

Here, for example, the number of layers used is three. A customer having a service level agreement (SLA0) interacts with a service 1 (SLA1) of a service provider A. The customer with SLA0 and service 1 with SLA1 further interact with service 2 (SLA2), service 3 (SLA3) and/or service 4 (SLA4) of a service provider B. At the physical layer, the interconnection is SLA0 to SLA1, SLA1 to SLA2, SLA2 to SLA3, and SLA3 to SLA4. At the logic layer, the interconnection is SLA0 to SLA2, SLA2 to SLA1, SLA2 to SLA3, and SLA2 to SLA4. At the quality-of-service layer, the interconnection is SLA0 to SLA2, SLA1 to SLA2, SLA2 to SLA3, and SLA2 to SLA4.

Turning now to FIG. 5, an extended service description to facilitate the realization of the three-layer decomposition is indicated generally by the reference numeral 500. Here, the enterprise service includes a service description, a logical perspective, a physical perspective, and a quality-of-service perspective. The service description includes a preamble, such as identification (ID), description, provider, and the like. The service description also includes a structure, such as structure details. The service description further includes an interface, such as connection methods.

The logical perspective includes a task such as a description, a role such as a role player, and a state such as a status. The physical perspective includes a transaction such as an execution artifact, a resource such as a service provider, and a probe such as a data collection. The quality-of-service perspective includes a service level agreement (SLA) target and a service level agreement result.

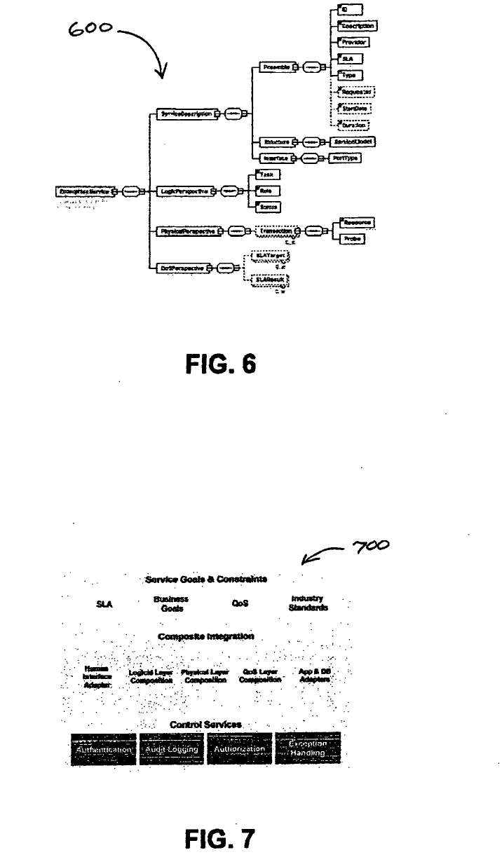

As shown in FIG. 6, an extended mark-up language (XML) schema for the extended service description that serves as the base for the implementation of the decomposition is indicated generally by the reference numeral 600. In the exemplary embodiment schema 600 of FIG. 6, a schema definition for an extended service description captures additional perspectives that are useful for the composite service management. Here, an enterprise service includes each of a service description, a logic perspective, a physical perspective, and a quality-of-service perspective.

The service description includes each of a preamble, a structure, and an interface. The preamble includes each of an ID, a description, a provider, a service level agreement, and a type. The preamble optionally includes a requestor, a start date, or a duration.

The logic perspective includes each of a task, a role, and a status. The physical perspective optionally includes any number of transactions, where each optional transaction may include a resource and/or a probe. The quality-of-service perspective optionally includes any number of service level agreement targets and/or service level agreement results.

Turning to FIG. 7, a modeling framework for managing composite enterprise services with a multi-layer decomposition is indicated generally by the reference numeral 700. Here, service goals and constraints comprise service level agreements, business goals, quality-of-service, and industry standards. Composite integration comprises human interface adapters, logical layer composition, physical layer composition, quality-of-service layer composition, and application and database adapters. Control services comprise authentication, audit logging, authorization, and exception handling.

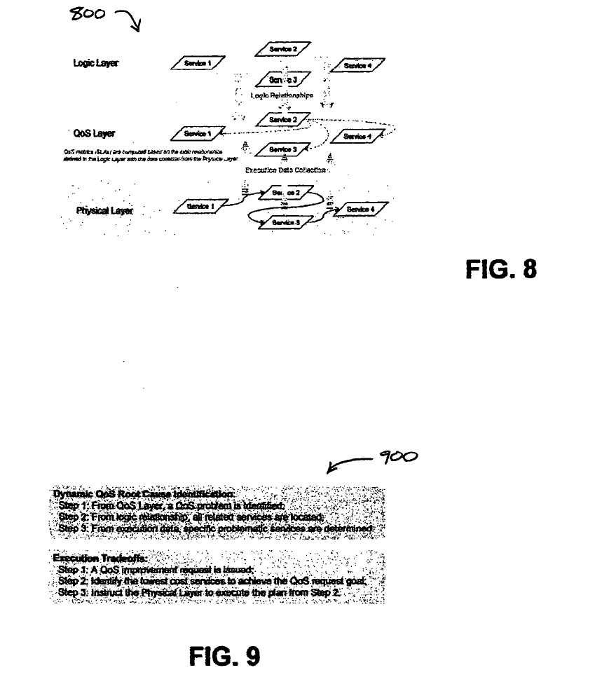

Turning now to FIG. 8, the interactions among the multiple layers of composite enterprise services are indicated generally by the reference numeral 800. In the exemplary embodiment enterprise services 800 of FIG. 8, a classification of the enterprise services facilitates the proper management of such services. In the logic layer, a service 2 is in signal communication with each of a service 1, a service 3, and a service 4. In a quality-of-service layer where quality-of-service metrics or SLAs are computed based on the logic relationships defined in the logic layer with the data collected from the physical layer, the service 2 is in signal communication with each of the service 1, the service 3, and the service 4. Thus, logic relationships are passed from the logic layer to the quality-of-service layer, and execution data collection is performed from the physical layer to the quality-of-service layer. In the physical layer, the service 1 is in signal communication with the service 2, the service 2 is in signal communication with the service 3, and the service 3 is in signal communication with the service 4.

As shown in FIG. 9, methods for managing composite enterprise services with multi-layer decomposition including problem identification and making tradeoffs are indicated generally by the reference numeral 900. Here, a dynamic quality-of-service root cause identification method includes a first step of identifying a quality-of-service problem from the quality-of-service layer; a second step of locating all related services from the logic relationship; and a third step of determining specific problematic services from the execution data.

An execution tradeoffs method includes a first step of issuing a quality-of-service improvement request; a second step of identifying the lowest cost services to achieve the quality-of-service request goal; and a third step of instructing the physical layer to execute the plan identified in the second step. Thus, in the exemplary embodiment methods 900 of FIG. 9, a method is disclosed for making tradeoffs for managing composite enterprise services with multi-layer decomposition.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the embodiments of present disclosure are programmed. Given the teachings herein, one of ordinary skill in the pertinent art will be able to contemplate these and similar implementations or configurations of the present disclosure.

Thus, the present disclosure sets forth an improved system and method for automatically managing composite enterprise services through multi-layer decomposition. Embodiments of the improved system and method obviate to an extent the prior need for manual management, particularly when applied in the context of complex composite systems that were heretofore difficult or impossible for even skilled operators to manage.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure.

What is claimed is:

1. A method of managing composite enterprise services, the method comprising:
performing a multi-layer decomposition of the composite enterprise services;
receiving at least one quality-of-service (QoS) request; and
managing the composite enterprise services in accordance with the multi-layer decomposition and the at least one quality-of-service request.

2. A method as defined in claim 1 wherein the composite enterprise services include at least one of business services or information technology (IT) services.

3. A method as defined in claim 1 wherein the multi-layer decomposition comprises at least three layers, the at least three layers including a logic layer, a quality-of-service layer, and a physical layer.

4. A method as defined in claim 1, further comprising defining a schema for an extended service description that captures additional perspectives.

5. A method as defined in claim 1 wherein the composite enterprise services include a service description, a logic perspective, a physical perspective, and a quality-of-service perspective.

6. A method as defined in claim 5 wherein the quality-of-service perspective includes a service level agreement (SLA) target and a service level agreement result.

7. A method as defined in claim 1 wherein the composite enterprise services include service goals and constraints, composite integration, and control services.

8. A method as defined in claim 3 wherein the composite enterprise services include quality-of-service metrics computed based on logic relationships defined in the logic layer with execution data collected from the physical layer.

9. A method as defined in claim 8, further comprising:
identifying a quality-of-service problem from the quality-of-service layer;
locating all related services from the logic relationships; and
determining specific problematic services from the execution data to achieve a dynamic quality-of-service root cause identification.

10. A method as defined in claim 8, further comprising:
issuing a quality-of-service improvement request;
identifying a plan using the lowest cost services to achieve the quality-of-service request; and
instructing the physical layer to execute the identified plan to achieve tradeoffs for managing composite enterprise services with multi-layer decomposition.

11. A method as defined in claim 1, further comprising classifying the composite enterprise services to facilitate the proper management of such services.

12. A system for managing composite enterprise services, the system comprising:
a processor;
a multi-layer decomposition unit in signal communication with the processor for performing a multi-layer decomposition of the composite enterprise services;
an adapter in signal communication with the processor for receiving at least one quality-of-service (QoS) request; and
a composite enterprise services management unit in signal communication with the processor for managing the composite enterprise services in accordance with the multi-layer decomposition and the at least one quality-of-service request.

13. A system as defined in claim 12, further comprising schema means in signal communication with the processor for defining a schema for an extended service description that captures additional perspectives.

14. A system as defined in claim 12, further comprising:
quality-of-service means in signal communication with the processor for identifying a quality-of-service problem from a quality-of-service layer;
logic means in signal communication with the processor for locating all related services from logic relationships; and
physical means in signal communication with the processor for determining specific problematic services from execution data to achieve a dynamic quality-of-service root cause identification.

15. A system as defined in claim 12, further comprising:
request means in signal communication with the processor for issuing a quality-of-service improvement request;
cost optimization means in signal communication with the processor for identifying a plan using the lowest cost services to achieve the quality-of-service request; and
physical means in signal communication with the processor for instructing a physical layer to execute the identified plan to achieve tradeoffs for managing composite enterprise services with multi-layer decomposition.

16. A system as defined in claim 12, further comprising classification means in signal communication with the processor for classifying the composite enterprise services into a plurality of service categories to facilitate the proper management of such services.

17. A program storage device readable by machine, tangibly embodying a program of instructions executable by the machine to perform program steps for managing composite enterprise services, the program steps comprising:
performing a multi-layer decomposition of the composite enterprise services;
receiving at least one quality-of-service (QoS) request; and
managing the composite enterprise services in accordance with the multi-layer decomposition and the at least one quality-of-service request.

18. A program storage device as defined in claim 17, the program steps further comprising defining a schema for an extended service description that captures additional perspectives.

19. A program storage device as defined in claim 17, the program steps further comprising:
identifying a quality-of-service problem from a quality-of-service layer;
locating all related services from logic relationships; and
determining specific problematic services from execution data to achieve a dynamic quality-of-service root cause identification.

20. A program storage device as defined in claim 17, the program steps further comprising:
issuing a quality-of-service improvement request;
identifying a plan using lowest cost services to meet the quality-of-service request; and
instructing a physical layer to execute the identified plan to achieve tradeoffs for managing composite enterprise services with multi-layer decomposition.
